(19) United States
(12) Patent Application Publication
(10) Pub. No.: US 2006/0185603 A1
(43) Pub. Date: Aug. 24, 2006

(54) Cold-weather Activated Cylinder and Feeder

(75) Inventor: William Joseph Rosener, Tahlequah, OK (US)

Correspondence Address: William Rosener, 820 Sasha Lane, Tahlequah, OK, 74464, US

(73) Assignee: William Joseph Rosener, Tahlequah, OK (US)

(21) Appl. No.: 10/906,490

(22) Filed: Feb. 23, 2005

(51) Int. Cl. A01K 39/00

(52) U.S. Cl. 119/51.02

(57) ABSTRACT

This invention describes a feeder where the accessibility automatically changes as the temperature changes. If a continuous supply of food cannot be made available to animals, the next best solution is to provide supplemental feed during cold conditions when animals must either consume more calories or eat richer food to help boost their metabolism to stay warm. To meet these needs, a cold-weather activated feeder has been designed and described in this document. The feeder can be created using either a cold-weather activation cylinder or a bimetallic coil. The cold-weather activation cylinder is a cylinder that extents and contracts as water freezes, taking advantage of the fact that water expands by approximately 9% as it freezes. The bimetallic coil approach uses a coil that expands and contracts whereby opening and closing the feeder. A feeder of this design would also be very beneficial for feeding animals in remote locations or for people taking vacations in the winter. At the same time, this feeder would encourage the animals to find natural food on warm days, when it is more readily abundant. In addition to automatically changing the accessibility, the feeder could display a message indicating whether it was opened or closed, whereby allowing someone to see from a distance the status of the feeder.

### BACKGROUND—FIELD OF INVENTION

This invention relates to feeders, and in particular to a device which can open and close a feeder when temperatures change. While the description and drawings focuses on birdfeeders, the idea is applicable to all feeders.

Birding as a hobby is one of America's favorite pastimes. A 1991 report from the U.S. Fish & Wildlife Service shows Americans spend more than $2.5 billion on birdseed and bird feeding supplies each year. An estimated 63 million people provide food for wild birds. That's approximately one out of every three people in the country! While some people feed birds year around, many people only feed birds in the winter months when it is difficult for birds to find food. This is especially the case, when the ground is frozen or covered with snow. During these times, it becomes much more difficult for birds to find insects and other natural foods.

Currently, bird feeders hold a supply of food and allow birds to continue eating until the supply is gone. These feeders do not adjust to meet the changing dietary needs of the birds based on weather conditions. For example, on cold days, birds must either consume more calories or eat richer food to boost their metabolism to stay warm. Unfortunately, depending on the number and types of birds in an area, many feeders only hold enough food for a few days, possibly going empty when birds could benefit the most from supplemental food.

To better meet the needs of birds and other animals, an invention known as a cold-weather activated feeder has been designed that automatically opens and closes as temperatures change. Using this invention, bird enthusiasts can let the temperature decide feeding preferences. The bird feeder could
(1) open only on cold days,
(2) release high-energy food on cold days,
(3) provide high-energy food on cold days and regular food on warm days if constructed as a dual feeder described below. (The feeder could also be designed to implement ideas described in Para 19.) Using a cold-weather activated birdfeeder, a bird enthusiast could better match the birds' needs by controlling the food supply or food type depending on the weather. This feeder would encourage the birds to find natural food on warm days, when it is more readily abundant. At the same time, this feeding approach would also allow bird enthusiast to provide more expensive, high-energy food on cold days. Likewise, less expensive food could be provided on warm days.

A visit to a local grocery store, and you will probably find at least 10 different bird seeds/mixtures containing: sunflower seeds, peanuts, maize, millet, oatmeal, safflower, canary seed, and corn. To attract particular birds, (e.g., finches) the bird enthusiast may have to purchase certain types of food. However, most bird seed mixtures come in at least two different quality levels (standard and high-energy). The more expensive, high-energy foods are often created by substitution. For example, by replacing sunflower hearts with sunflower seeds or by replacing premium peanuts with standard peanut granules a high-energy food can be created. Typically, as the percentage of fat and protein increase, so does the price. The following table shows a break-down of some of the foods commonly fed to birds.

| Food | Protein (min) | Fat (min) | Cost per pound. |
|---|---|---|---|
| Cracked corn | 7% | 3% | $0.10 |
| Sunflower seeds | 14% | 20% | $0.26 |
| Thistle seeds | 20% | 39% | $0.80 |

An adaptable bird feeder would also be very beneficial for feeding birds in remote locations or for people taking vacations in the winter. If a continuous supply of food cannot be made available for birds, the next best solution is to provide supplemental feed during extremely cold conditions (e.g., when the ground is frozen or covered with snow). Considering 25 percent of a bird's diet comes from human handouts, the ability for birds to gain access to food in extremely cold weather may make a “life or death” difference.

The feeder could be constructed as a dual feeder. One section (or sections) could be open regardless of the temperature, and a second section could be cold-weather activated. In the cold-weather activated section, a high-energy food could be stored, or it could be used as a backup supply during cold days. Using this approach a bird enthusiast would only have to purchase one bird feeder to meet their daily and vacation needs.

The cold-weather activated birdfeeder could be constructed using different techniques. Paragraph 9 describes how a bimetallic coil could be used to regulate access. Paragraphs 10-15 describe how a cold-weather activated cylinder could regulate access to the feeder.

A cold-weather activated bird feeder could be constructed by taking a regular bird feeder and adding access doors that open and close using a bimetallic coil. A bimetallic coil is made of two different metals with different rate of expansion that are bonded together. The coil is connected to access doors. As temperatures warm, the coil expands closing access to the feeder. As temperatures cool, the coil contracts allowing access to the feeder. The working model, of this invention automatically closes at approximately 70° F. and starts opening up as temperatures get cooler. However, the temperature at which the feeder opens or closes can easily be changed. An adjustment mechanism and gauge would allow the user to easily set the temperature range at which the access doors would open and close. The access doors could open and close either vertically or horizontally or they could slide back and forth. If placed horizontally, a single access door would be adequate for each side. Regardless of the direction, the access doors could be clear giving birds more visibility, as well as allowing people to see the food in the feeder.

A cold-weather activated birdfeeder could also be constructed by using a cold-weather activated cylinder. A cold-weather activated cylinder is a cylinder that extents and contracts as water freezes. The cylinder could be indirectly connected to a reservoir using pipes or hoses or it could be directly connected to a reservoir by threads. The reservoir would contain water and most likely a substance like oil which would help lubricate the walls of the cylinder. The water and oil would most likely be separated with a bladder. However, a bladder would not be required. This is because oil is lighter than water and would float to the top. But, if the bird feeder was to be accidentally placed on its side, the bladder would prevent water from entering the cylinder unit causing damage. As temperatures get cold, the water in the reservoir freezes. The freezing water expands (by approximately 9%) pushing the oil into the cylinder which moves a piston which moves a rod which opens the feeder. When temperatures warm up, the ice melts and springs push the rod back into the cylinder closing the bird feeder. As water freezes, so does the pressure it can exert. At 0 degrees Celsius, freezing water only exerts a little pressure. As temperatures get colder so does the pressure. For example, at −22 degrees Celsius, ice can exert approximately 40,000 lbs. per square inch of pressure. Obviously, the bird feeder would open before requiring this amount of pressure.

The reservoir could be of various shapes including trapezoid, cylinder (submarine), sphere, etc. Along the same lines, multiple bladders could be used. It would be like inserting multiple water balloons into the reservoir. In the case of the submarine or sphere, it might be best to limit the water, to slightly less than half of the capacity. This way, if the bladder broke and the water froze, it would not break the reservoir. While not shown in the illustrations the bladder could be secured to the bottom allowing the cold-weather activated cylinder to work in any direction, and it could be regulated from outside the reservoir, similar to how air can be entered into a bike tube, without removing the tube from the tire. Finally, an entry point would most likely be created to allow the bladder to be placed inside the reservoir, after the reservoir was created.

The temperature at which the cold-weather activated birdfeeder opens and closes could be modified. For example, antifreeze, ethylene glycol, salt, glycerin and other impurities could be added to lower the temperature at which it opens. Physical changes such as pressure alteration can change the freezing point. Because water expands as it freezes, a lower pressure will increase the temperature at which water freezes. (Conversely, increased pressure will decrease the freezing point of water.) By adding various substances to water, the cold-weather activated birdfeeder could be marketed for different areas and climates. For example, it could be configured to open at −5°, −10°, −15°, −20° Celsius.

As a safety measure, a pressure release value could be installed to prevent something from breaking if the water expansion calculations were incorrect in the manufacturing. Note: the designs shown in the drawings allow for a slightly incorrect calculation or in other words do not require the water to be completely frozen before opening the bird food release doors. This is accomplished by having the cylinder immediately open the bird food release doors. Even once the doors are completely opened, the cylinder can continue to extend outward without causing any damage.

For adjustability, the end of the piston/rod could contain threads with a short pipe screwed on the end. This short pipe would serve as an adjustment mechanism. By turning this short pipe either clockwise or counter-clockwise, the cylinder would activate sooner or later.

The cold-weather activated cylinder can be created using regular one-way and two-way cylinders on the market. If a two-way cylinder is used, it would most likely require an air vent on the one end. For this reason, an air intake vent is shown in FIG. 1.

Sunlight is shielded from directly shining on the reservoir or cylinder. This prevents it from closing on cold, yet sunny days. At the same time, air vents help ensure as much air as possible reaches the reservoir. Thereby, reducing the time required to open or close the bird feeder. Similarly, if a bimetallic coil is used, it would be shielded from direct sunlight.

In addition to opening and closing a birdfeeder, a cold-weather activated cylinder could be used for numerous other applications. It could be used as a source of energy. For example, it could raise a heavy weight. As the weight lowers, this energy could be converted to a more useable type of energy. As another example, the cold-weather activated cylinder could raise and lower a warning sign on a bridge that says “Watch for Ice on Bridge.” Or the cold-weather activated cylinder could turn on and off a heating switch. The big advantage of the cold-weather activated cylinder is that it combines a sensor with power. To automatically raise a 30 pound sign in the air when temperatures are freezing without a cold-weather activated cylinder would require 3 items. A sensor, a source of power (e.g., an electric motor), and a power supply (e.g., electricity). Running a power supply to a remote bridge or a remote bird feeder could be very expensive.

In addition to opening and closing a birdfeeder, the movement of the cold-weather activated cylinder or bimetallic coil would display a message indicating whether the birdfeeder was opened or closed. This could be accomplished by raising a sign that says “OPEN” as shown in FIGS. 1-4. Another way, would be rotating a sign that says “OPEN” and “CLOSED” as shown in FIG. 5 and 6. In this case, only one of the two words could be viewable at any moment.

This idea also includes the following extensions:
(1) Enlarging and reducing the feed opening. On cold days, the openings could be enlarged to make it easier for birds to get food. During warm days, the openings could be reduced, making it more difficult for birds to get food.
(2) Integrating various sized screens. Depending on the bird seed chosen, various screens size could be used to restrict food movement.
(3) Installing fixed wire panel. A wire panel could be installed which restricts large birds and squirrels from accessing the feeder.
(4) Using only water. The cold-weather activated birdfeeder could be designed using only water to push a moveable piston which in turn moves an arm to open and close the bird feeder.
(5) Using water with and without antifreeze. Water without antifreeze could be placed in the bladder, and water with antifreeze could be use to activate the cylinder. This point acknowledges the fact that cylinders today exist on the market which are raised and lowered using water.
(6) Opening and closing bottom door. The birdfeeder could be designed where it simply opened up a bottom door, dropping food on the ground.
(7) Feeding options. In addition to birds, the feeder could also be used to feed squirrels, deer, and other animals.

This paragraph provides a static description of the figures and the reference numerals used in the drawings. Five different designs are shown FIGS. 1-12 illustrate four different feeder designs that use a cold-weather activated cylinder. FIGS. 13 and 14 illustrate a feeder that uses a coil that expands and contracts as the temperature changes. In FIGS. 1-4 the cylinder is located in a vertical position. In FIGS. 5-8 the cylinder is located in a horizontal position. In FIGS. 9 and 10 the cylinder is located besides the reservoir. In FIGS. 11 and 12 the sides are raised and lowered (or worded another way the bottom is raised and lowered). To help simplify the drawings, perches are not illustrated. The figures are not necessarily drawn to scale. FIGS. 1, 2, 3, 4, 9, and 10 illustrate that the reservoir can be trapezoid shaped. FIGS. 5, 6, 7, 8, 11, and 12 illustrate that the reservoir can be “submarine” shaped.

### DRAWING FIGURES

FIG. 1 shows a front view of a bird feeder with a cylinder in a vertical “closed” position. Only the center and the right side are illustrated. The left side would be the mirror image of the right side.

FIG. 2 shows a front view of a bird feeder with a cylinder in a vertical “open” position. Only the center and the right side are illustrated. The left side would be the mirror image of the right side.

FIG. 3 shows a side view of bird feeder with a cylinder in a vertical “closed” position.

FIG. 4 shows a side view of a bird feeder with a cylinder in a vertical “open” position.

FIG. 5 shows a front view of bird feeder with a cylinder in a horizontal “closed” position.

FIG. 6 shows a front view of a bird feeder with a cylinder in a horizontal “open” position.

FIG. 7 shows a top view of bird feeder with a cylinder in a horizontal “closed” position.

FIG. 8 shows a top view of a bird feeder with a cylinder in a horizontal “open” position.

FIG. 9 shows a front view of a bird feeder with a cylinder in a vertical “closed” position.

FIG. 10 shows a front view of a bird feeder with a cylinder in a vertical “open” position.

FIGS. 11 and 12 show a side view of how the walls of the birdfeeder could be raised and lowered to give birds access to the food.

FIGS. 13 and 14 show how a bimetallic coil could be used to regulate access to a feeder.

### REFERENCE NUMERALS IN DRAWINGS

20 reservoir 56 pressure release value

22 water 58 roller

24 bladder 60 swivel

26 oil 62 push bar

28 cylinder 64 hose/pipe

30 rubber seal (cylinder) 66 stopper

32 piston/rod 68 cylinder support

34 air-intake hole 70 open/close arm

36 feed door spring 72 arm spring

38 piston compress springs mount 74 rubber seal (indicator)

40 hinge 76 synchronization rod

42 rod 78 cover open plate sign

44 piston compress spring 80 stationary pivot

46 open indicator 82 moveable pivot

48 open/closed indicator 84 bimetallic coil

50 bird food 86 open/close doors

52 bird food release door 88 regular birdfeeder

54 air vent

### DESCRIPTION OF FIGURES

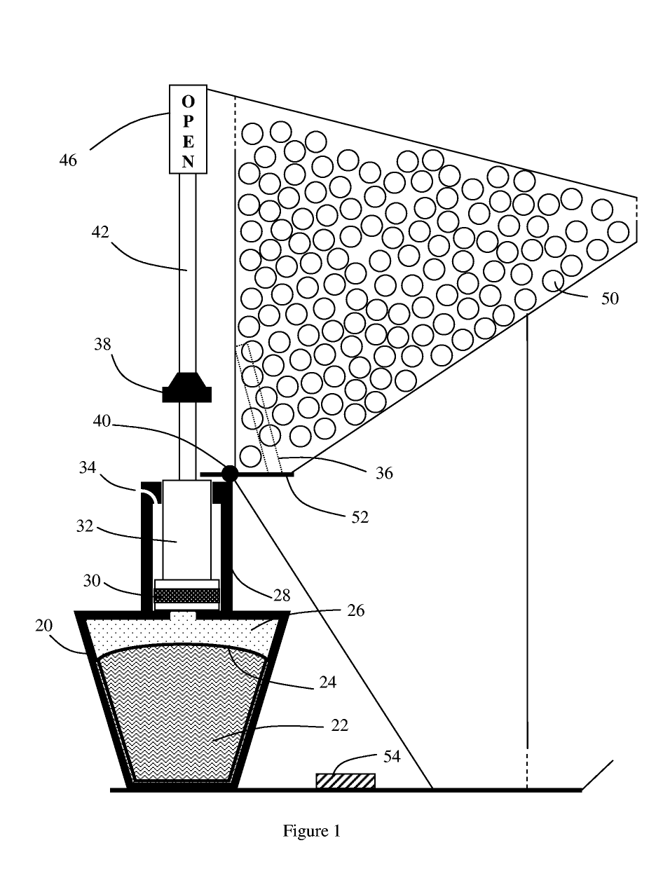

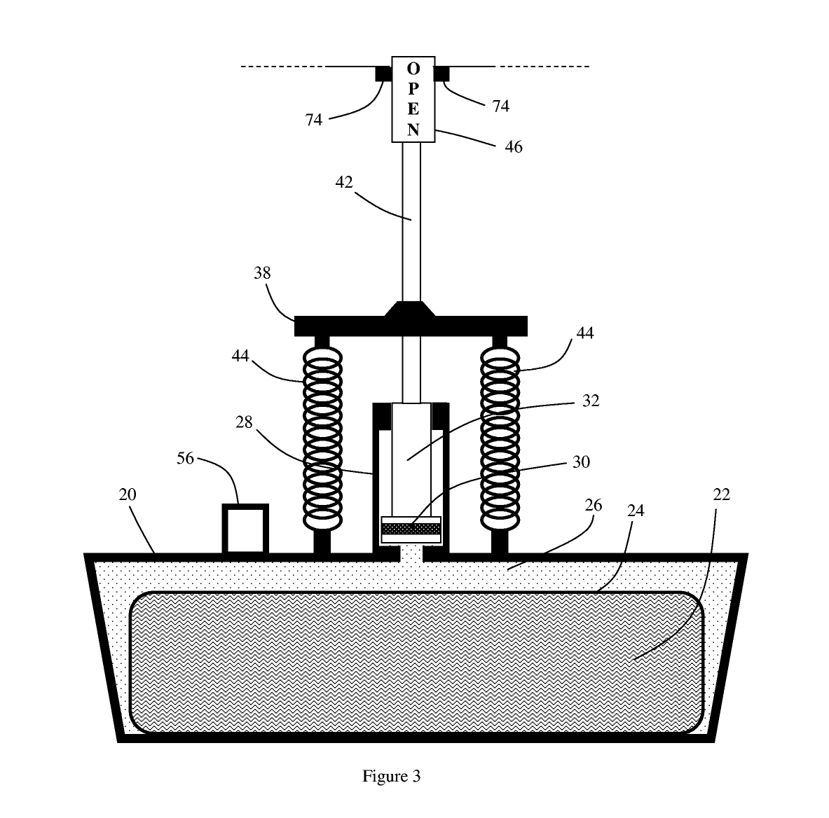

FIGS. 1 and 3 show a bird feeder that has the cold-weather activated cylinder placed in a vertical position. In both figures, the feeder is closed. Only the center and the right side are illustrated in FIG. 1. The left side would be the mirror image of the right side. The water in the reservoir has not frozen and expanded and hence no pressure is being applied to the piston 32. Therefore, the feed door springs 36 hold the bird food release doors 52 closed so no seed can go to the feeding areas. The open indicator 46 does not appear above the top of the feeder.

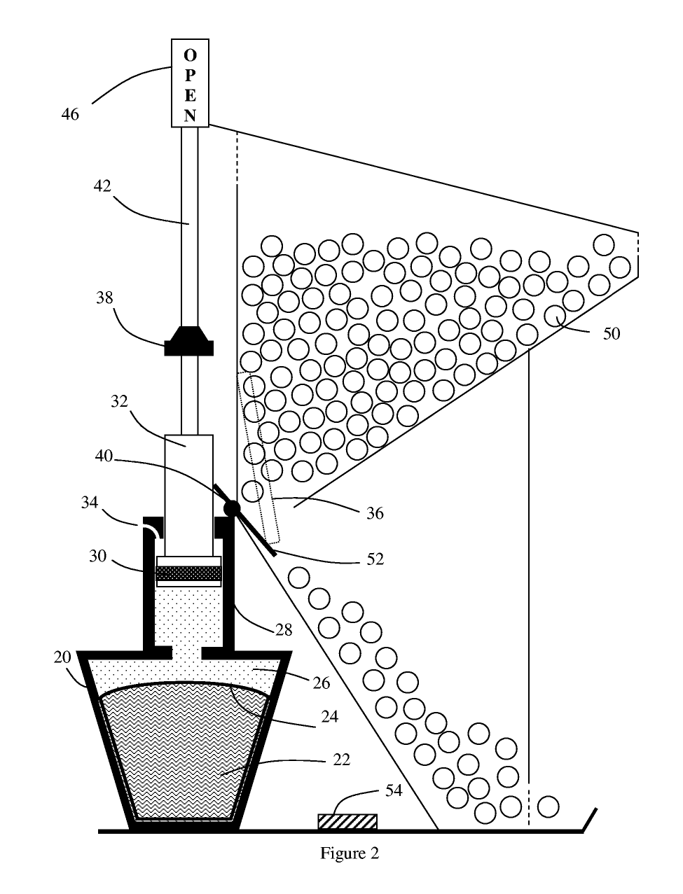

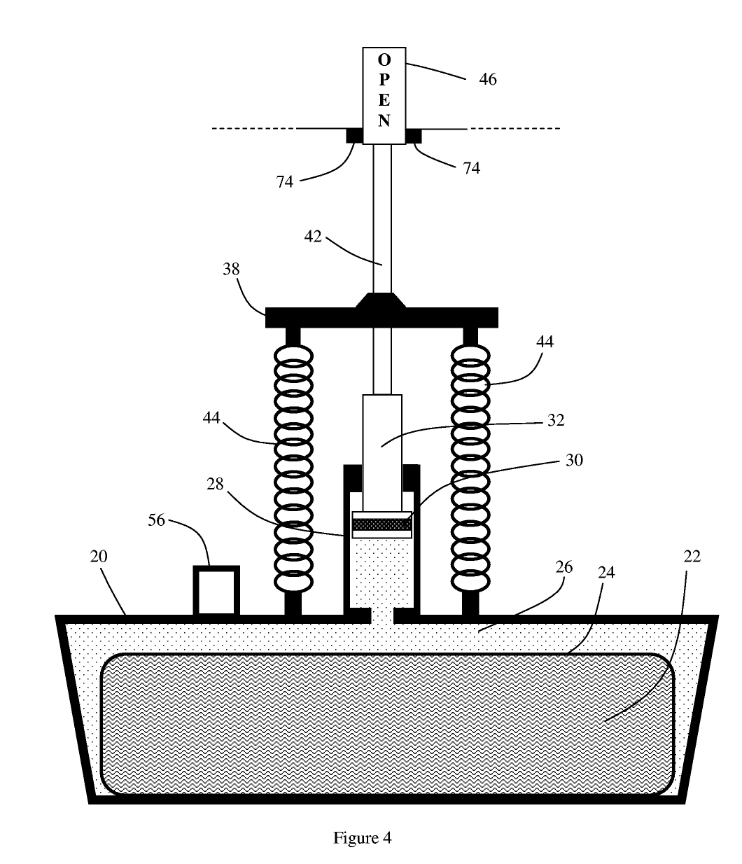

FIGS. 2 and 4 show a bird feeder that has the cold-weather activated cylinder placed in a vertical position. In both figures, the feeder is open. Only the center and the right side are illustrated in FIG. 2. The left side would be the mirror image of the right side. Because of freezing expanding water, more pressure is being applied to the piston 32 than the cylinder springs 44 and feed door springs 36 can hold back. Therefore, the bird food release doors 52 open and bird seed moves to the feeding areas. The open indicator 46 now appears above the top of the feeder.

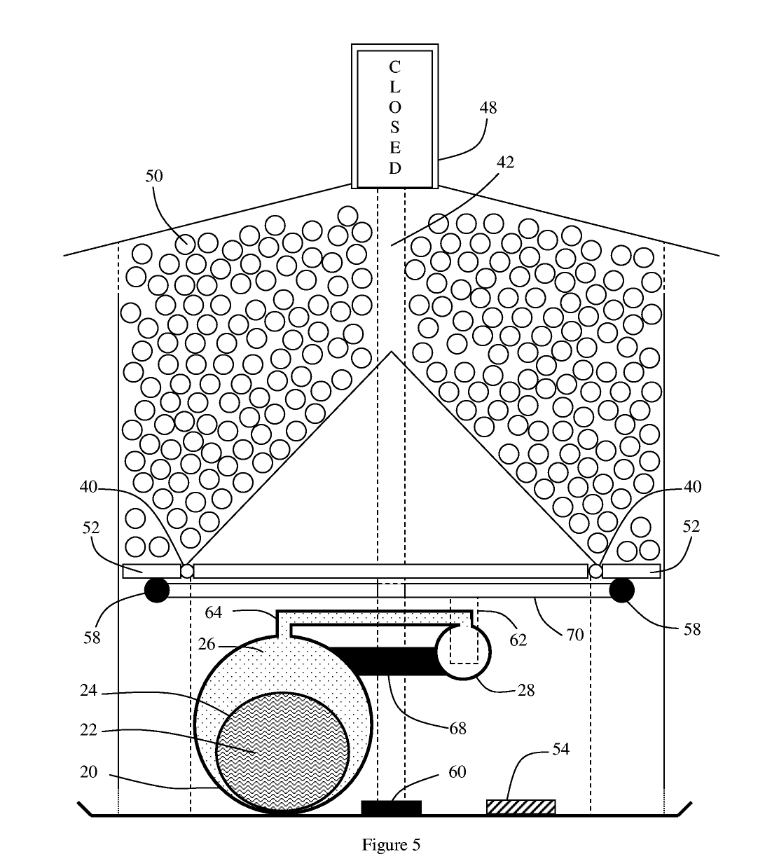

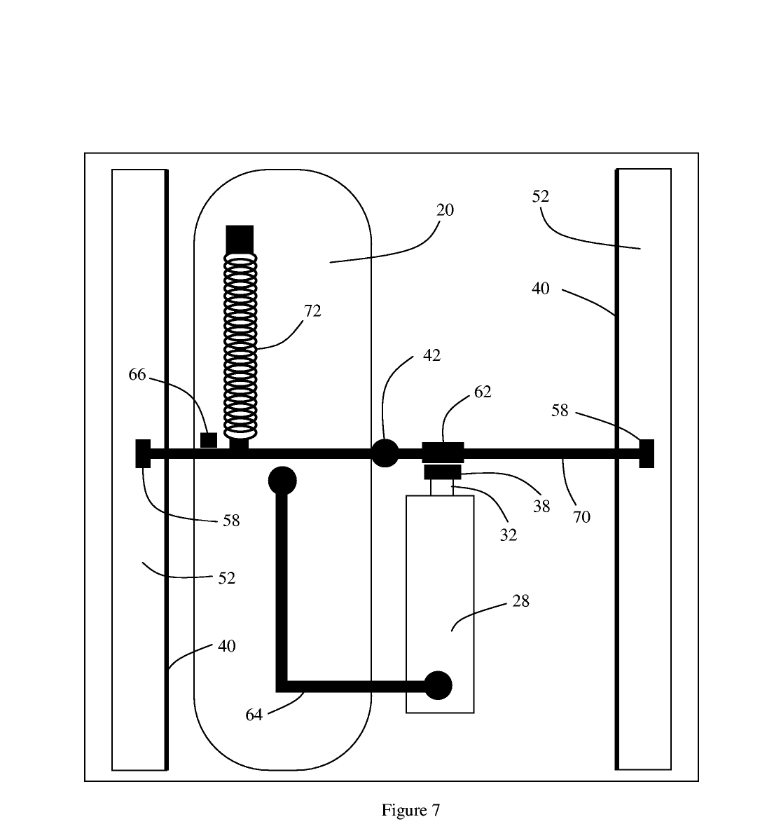

FIGS. 5 and 7 show a bird feeder that has the cold-weather activated cylinder placed in a horizontal position. In both figures, the feeder is closed. The water in the reservoir has not frozen and expanded and hence no pressure is being applied to the piston/rod 32. Therefore, arm spring 72 holds the bird food release doors 52 closed so no seed can go to the feeding areas. The open/closed indicator 48 is rotated such that the text “CLOSED” is visible and “OPEN” is hidden.

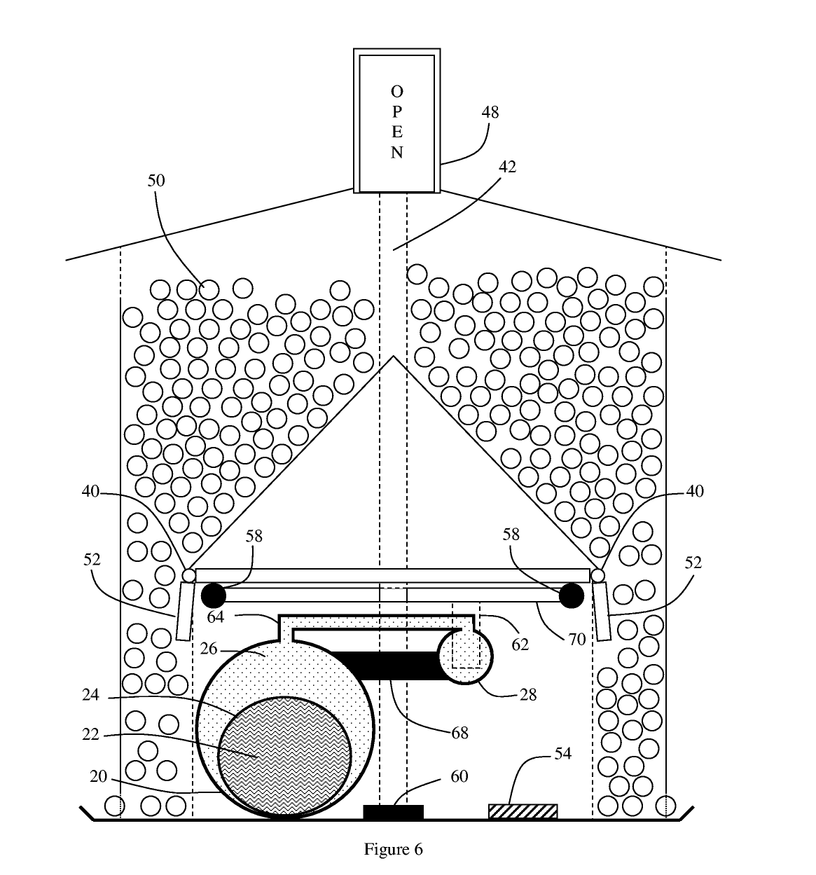

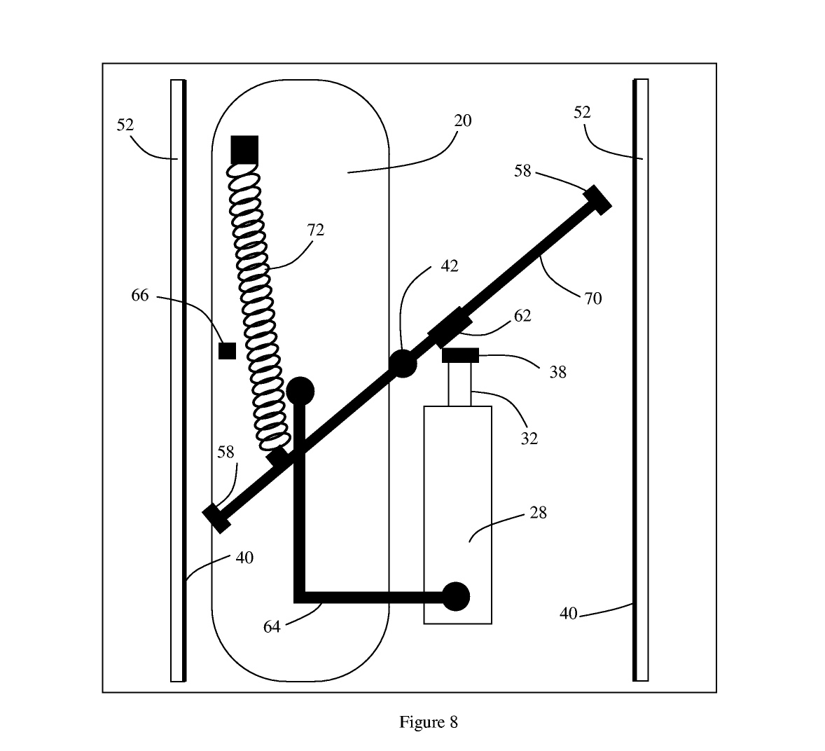

FIGS. 6 and 8 show a bird feed that has the cold-weather activated cylinder places in a horizontal position. In both figures, the feeder is open. Because of freezing expanding water, the piston/rod 32 moves applying more pressure to the push bar 62 than the arm spring 72 can hold back. Therefore, the bird food release doors 52 open and bird seed moves to the feeding areas. The open/closed indicator 48 is rotated such that the text “OPEN” is visible and the text “CLOSED” is hidden.

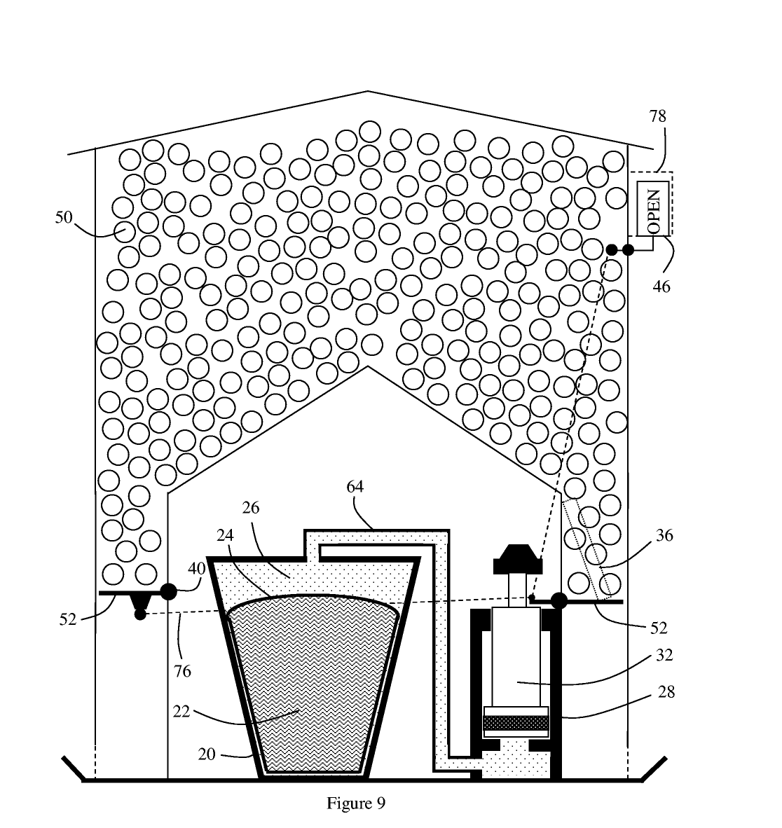

FIG. 9 shows a bird feeder that has the cold-weather activated cylinder placed in a vertical position. This is similar to the example shown in FIG. 1 except, the cylinder is located to the right of the reservoir. (In FIG. 1 the cylinder is located on top of the reservoir.) The water in the reservoir has not frozen and expanded and hence no pressure is being applied to the piston 32. Therefore, the feed door springs 36 hold the bird food release doors 52 closed so no seed can go to the feeding areas. The open indicator 46 is hidden behind the cover open plate sign 78.

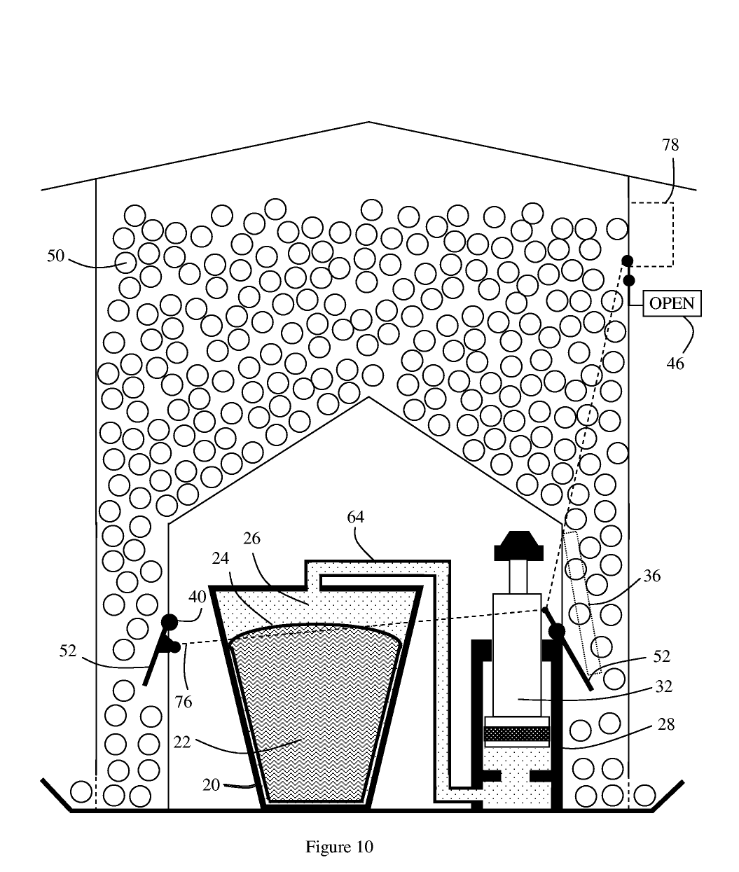

FIG. 10 shows a bird feeder that has the cold-weather activated cylinder placed in a vertical position. This is similar to the example shown in FIG. 2 except, the cylinder is located to the right of the reservoir. (In FIG. 2 the cylinder is located on top of the reservoir.) Because of freezing expanding water, more pressure is being applied to the piston 32 than the cylinder springs and feed door springs 36 can hold back. Therefore, the bird food release doors 52 open and bird seed moves to the feeding areas. The open indicator 46 is exposed.

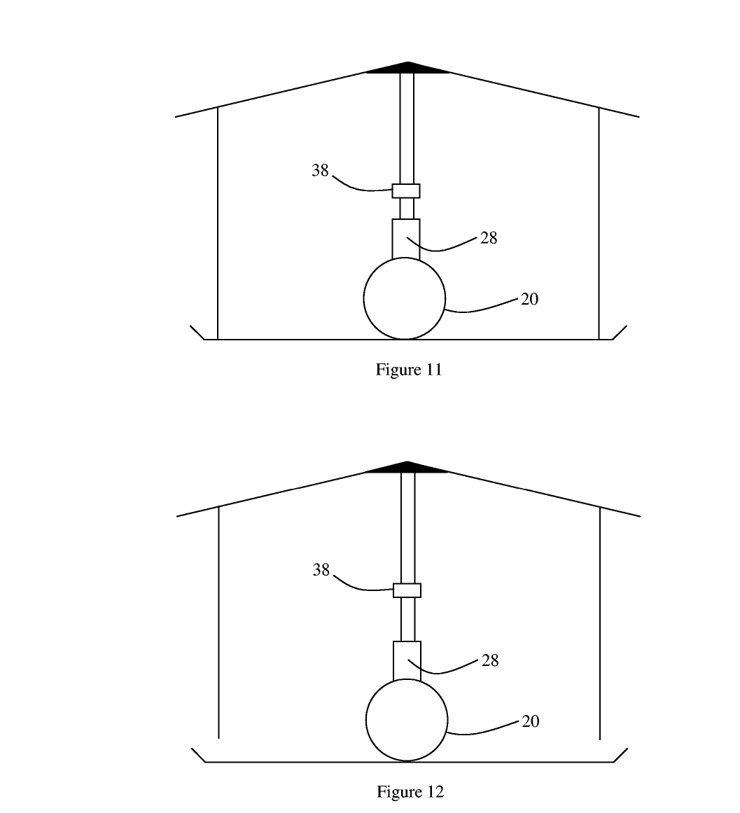

FIGS. 11 and 1 2 show a bird feeder that has the cold-weather activated cylinder placed in a vertical position. In this example, the walls of the birdfeeder are raised and lowered to give birds access to the food. Or thought of as another way, the bottom is lowered.

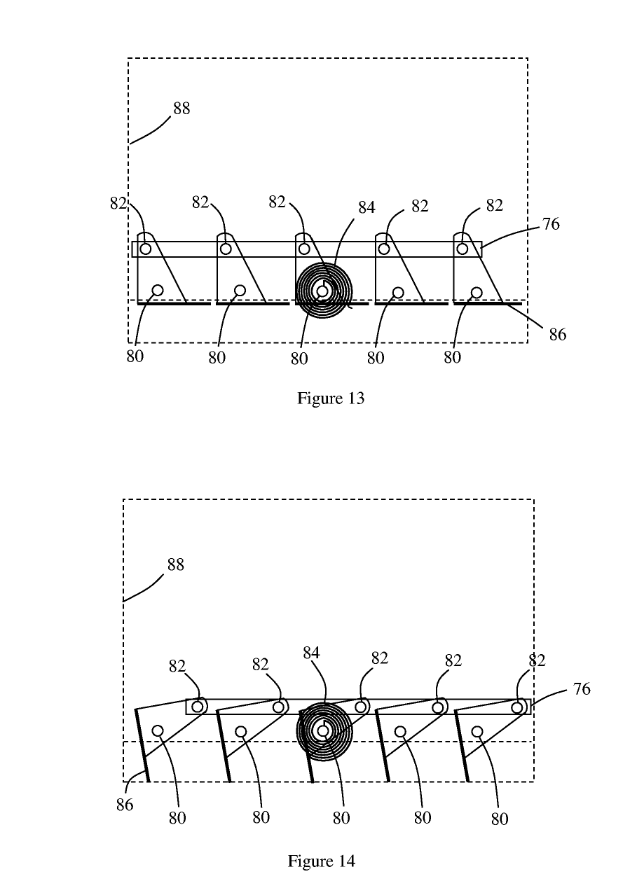

FIGS. 13 and 14 show a top view of how a bimetallic coil could be used to regulate a bird feeder. In this example, a regular birdfeeder 88 was modified with access doors that open and close using a bimetallic coil. In FIG. 13, the access doors to the feeder are closed. In FIG. 1 4, the access doors are open. All access doors are connected using a synchronous rod 76. Hence, when one access door opens, all access doors open. Conversely, when one access door closes, all access doors close. In FIG. 1 3 the temperature is warm causing the bimetallic coil 84 to expand closing all access doors 86. In FIG. 14 the temperature is cool causing the bimetallic coil 84 to contract opening all access doors 86.

The descriptions listed above should not be construed as limiting the scope of the invention but as merely providing illustrations of some of the presently preferred embodiments of this invention. For example, the bird feeder could be round, square, rectangular, or polygonal; the cold-weather activated cylinder could be at various angles and directions; and reservoir could be trapezoid, cube, sphere, cylinder shaped etc; one or more bladders could be used; substances could be added to change the activation temperature; one or more cylinders could be used; the access doors in the bimetallic coil approach could open either vertically, horizontally, or could slide back and forth; the temperature setting of the bimetallic coil could be adjustable and could include a gauge, etc.

What is claimed is:

1. What I claim as my invention is a cylinder device that automatically extends due to the expansion of water freezing and then contracts as the water warms, whereby combining a sensor with power.

2. The cylinder of claim 1 wherein could use a reservoir filled with water and oil.

3. The reservoir of claim 2 wherein could use a bladder to separate the water and oil where said bladder could be fastened to the reservoir, whereby allowing the cylinder to operate in any position.

4. The reservoir of claim 3 could be various sizes and shapes including trapezoid, cube, cylinder, or a sphere.

5. The water of claim 1 wherein could contain a substance to increase or decrease the temperature of activation.

6. The system of claim 1 wherein could be altered using pressure.

7. What I claim as my invention is a feeder device where the accessibility automatically changes as the temperature changes.

8. The feeder of claim 7 wherein could operate using a cold-weather activation cylinder or a material that expands and contracts as temperatures change, such as a metallic coil.

9. The metallic coil of claim 8 could have an adjustment mechanism and gauge to allow the user to regulate access temperatures.

10. The feeder of claim 7 wherein could open on cold days and close on warm days.

11. The feeder of claim 7 wherein could be used to feed birds, squirrels, deer, wild and domestic animals, etc.

12. The feeder of claim 7 wherein could be configured as a dual feeder, where one section always remained opened.

13. The feeder of claim 7 could drop food on the ground.

14. The feeder of claim 7 wherein could enlarge or reduce the feed opening, whereby making it easier for birds to get food on cold days.

15. The feeder of claim 7 wherein could use a fixed wire panel, whereby restricting large birds and squirrels from accessing the food.

16. The feeder of claim 7 wherein could be made squirrel proof.

17. The feeder of claim 7 wherein could integrate various sized screens, whereby allowing various food sizes to be used.

18. What I claim as my invention is a status indicator on a feeder that changes based on whether a feeder is open or closed, whereby allowing someone to see from a distance the status of the feeder.

19. The status indicator of claim 18 wherein could be raised and lowered.

20. The status indicator of claim 18 wherein could rotate between different sayings.
